(19) United States
(12) Patent Application Publication
(10) Pub. No.: US 2014/0103140 A1
(43) Pub. Date: Apr. 17, 2014

(54) COMBINATION INFLATABLE PROTECTIVE COVER AND LIQUID SOAP DISPENSER FOR WATER FIXTURES

(71) Applicant: M. Rosemary Busby, Lewisville, TX (US)

(72) Inventor: M. Rosemary Busby, Lewisville, TX (US)

(21) Appl. No.: 13/649,211

(22) Filed: Oct. 11, 2012

(51) Int. Cl. B05B 1/00; B23P 11/00

(52) U.S. Cl. 239/211; 29/446

(57) ABSTRACT

A combination inflatable protective cover and liquid soap dispenser for a water ejecting fixture. An inflatable protective cover having an interior opening and first and second apertures in communication with the interior opening and a liquid soap dispenser having a narrow aperture adjacent the second aperture where water from the fixture is ejected. Liquid soap flows out of the liquid soap dispenser by gravity into the tub alongside the water from the water ejecting fixture.

### TECHNICAL FIELD

This disclosure relates to an inflatable protective cover for a water fixture which incorporates a liquid soap dispenser.

### BACKGROUND OF THE INVENTION

The use of a combination liquid soap dispenser and protective cover for various types of water fixtures is known in the art. For example, U.S. Pat. No. 5,125,577 to Frankel discloses a combination liquid soap dispenser and protective cover formed of a relatively rigid, molded rubber material for a water ejecting bathtub fixture. Pressure produced by the flow of water through the device draws liquid soap out of a dispenser where it mixes with the water flow before exiting the device.

### SUMMARY OF THE INVENTION

In one aspect, the present invention comprises a combination inflatable protective cover and liquid soap dispenser for a water ejecting fixture comprising an inflatable protective cover which forms an interior opening upon inflation, the interior opening being sized to receive the water ejecting fixture for supportably mounting the inflatable protective cover on the fixture, wherein the inflatable protective cover has a liquid soap dispenser having at least one liquid soap dispensing aperture capable of dispensing liquid soap adjacent to the water ejected from the water ejecting fixture.

### BRIEF DESCRIPTION OF THE DRAWINGS

For a more complete understanding of this disclosure and its features, reference is now made to the following description, taken in conjunction with the accompanying drawings, in which:

FIG. 1 is a perspective view of a first embodiment of a combination inflatable protective cover and liquid soap dispenser constructed in accordance with the teachings of the present invention;

FIG. 2 is a cross-sectional view of the combination inflatable protective cover and liquid soap dispenser of FIG. 1;

FIG. 3 is a bottom view of the combination inflatable protective cover and liquid soap dispenser of FIG. 1; and

FIG. 4 is a top view of the combination inflatable protective cover and liquid soap dispenser of FIG. 1.

### DETAILED DESCRIPTION OF THE INVENTION

It is an object of this invention to provide an inflatable protective cover for a water ejecting bathtub fixture which when inflated and mounted to the fixture provides a liquid soap dispenser which dispenses liquid soap into the bath adjacent to the flow of water from the fixture.

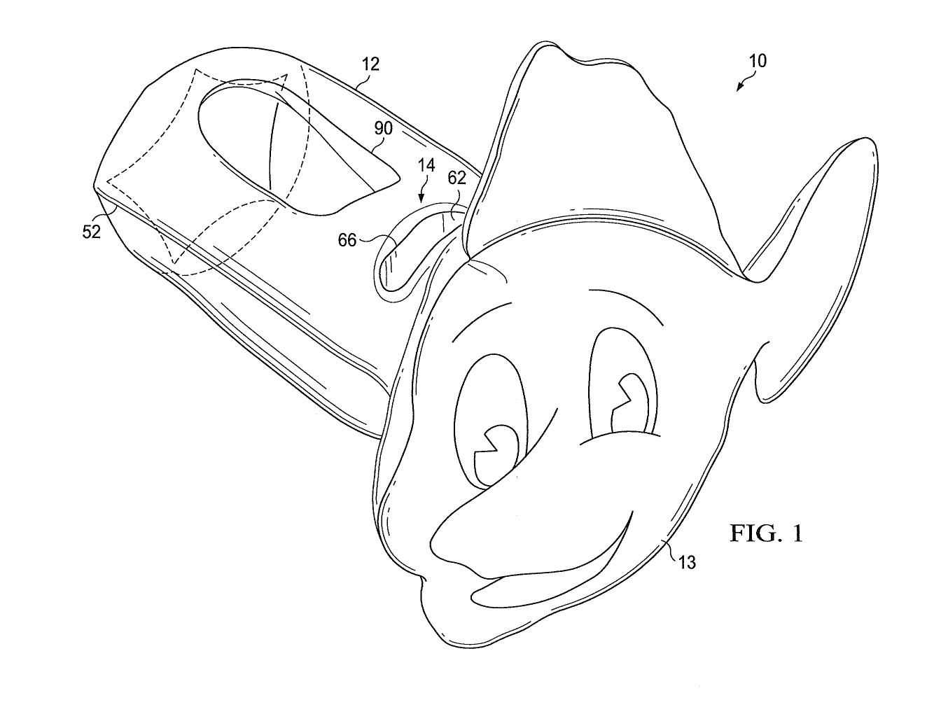

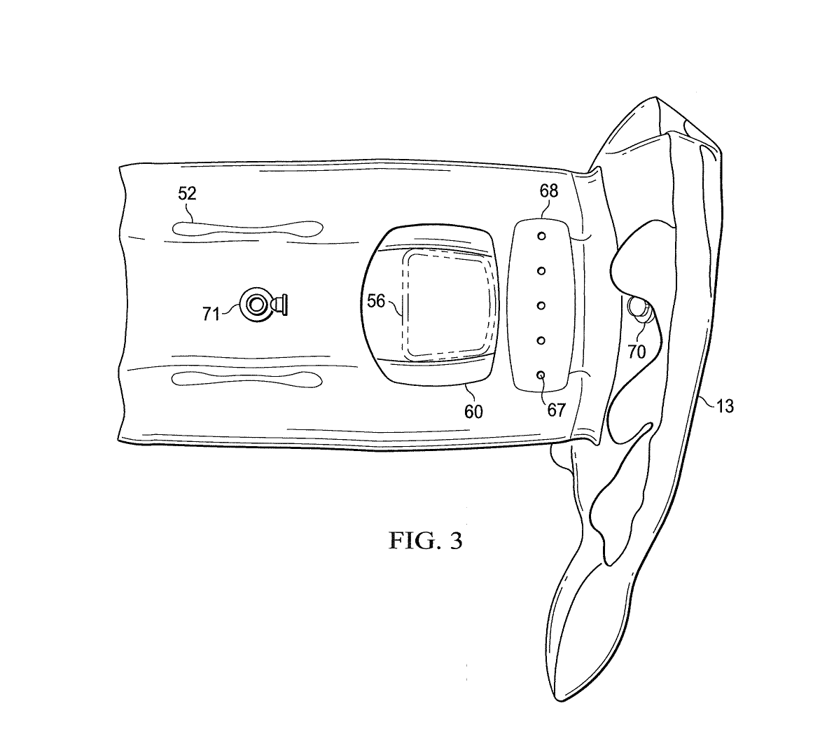

Referring now to the drawings wherein like reference numerals designate identical or similar elements throughout the several views, depicted in FIG. 1 is a combination inflatable protective cover and liquid soap dispenser 10 constructed in accordance with the teachings of the present invention. The combination inflatable protective cover and liquid soap dispenser 10 is comprised of an inflatable protective side cover 12, an inflatable protective front cover 13, and a liquid soap dispenser 14. All of which are preferably constructed of a soft vinyl material. Accordingly, in the event that the head or other portion of a child's body accidentally strikes a water ejecting fixture, most commonly constructed of a hardened material such as steel, to which the combination inflatable protective cover and liquid soap dispenser 10 is mounted the combination inflatable protective cover and liquid soap dispenser cushions the impact of the blow, thereby reducing the likelihood of serious injury. In the preferred embodiment of the invention the inflatable protective front cover 13 should include pictorial art work and be shaped so that when inflated, it forms a three dimensional object of interest to a child such as a fish as shown in FIGS. 1-4, other animal, cartoon figure, or other sculptural work.

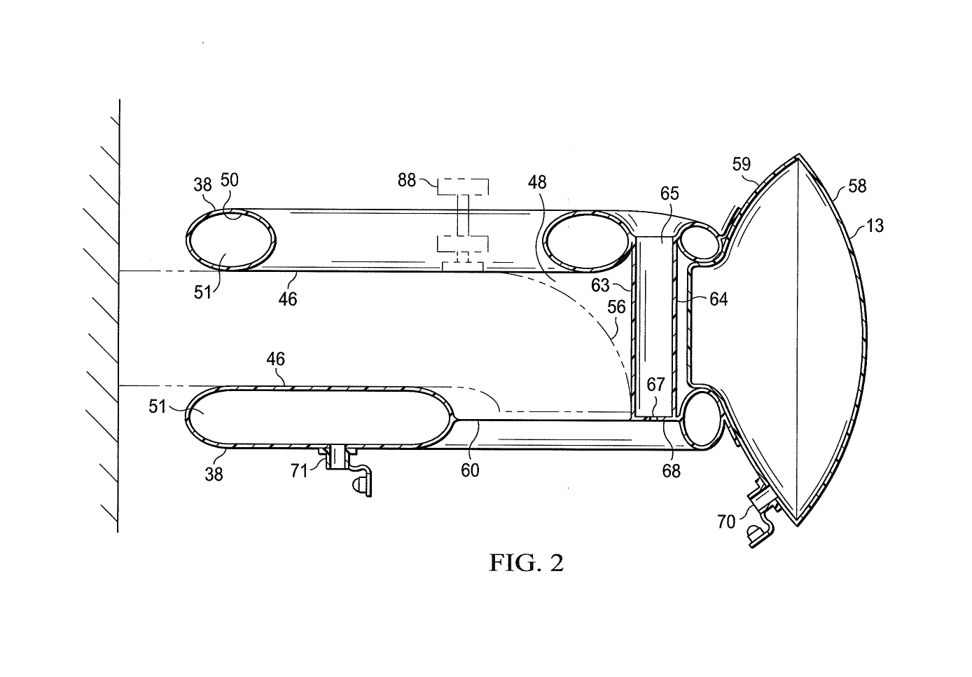

Referring next to FIG. 2, the combination inflatable protective cover and liquid soap dispenser 10 illustrated in FIG. 1 shall now be described in greater detail. The inflatable protective side cover 12 is comprised of an exterior sidewall 38 and interior sidewall 46. The interior sidewall 46 defines a water fixture receiving interior opening 48. The exterior sidewall 38 and interior sidewall 46 have an inner surface 50. When the inflatable protective side cover 12 is inflated, the inner surface 50 defines multiple chambers 51 within the inflatable protective side cover 12 which are in communication with each other. As shown in FIG. 1, the multiple chambers 51 are preferably formed using one or more lateral heat welds 52 that attach portions of the exterior sidewall 38 to portions of the interior sidewall 46.

The inflatable protective front cover 13 is comprised of a forward wall 58 attached to a rearward wall 59, preferably using a heat weld along their respective edges. The forward wall 58 may include art work that makes the inflatable protective front cover 13 resemble an object of interest to a child, as previously described with respect to FIG. 1. The inflatable protective front cover 13 is attached to the inflatable protective side cover 12. This can be done by welding the vinyl components together. In another embodiment, the inflatable protective front cover 13 can be formed integrally with the inflatable protective side cover 12 to create a single inflatable unit. When formed as separate inflatable units, the inflatable protective front cover 13 is inflated by blowing air into plastic air valve 70 and the inflatable protective side cover 12 is inflated by blowing air into plastic air valve 71. When formed integrally, only a single plastic air valve is used to inflate the combination inflatable protective cover and liquid soap dispenser 10.

To mount the combination inflatable protective cover and liquid soap dispenser 10 to a water ejecting fixture 56 (illustrated in phantom in FIG. 2) such as a bathtub spout, the inflatable protective side cover 12 is first inflated and then placed over the fixture 56 such that the fixture 56 is inserted into the interior opening 48 until the front edge of the fixture 56 engages the liquid soap dispenser 14. The fixture 56 engages the interior sidewall 46 of the inflatable protective side cover 12 to support the combination inflatable protective cover and liquid soap dispenser 10 on the fixture 56.

The interior opening 48 terminates in an exit aperture 60. When water is ejected by the fixture 56, for example, by actuating a bathtub faucet or spigot sufficient to open the faucet flow opening, the ejected water exits the combination inflatable liquid soap dispenser and protective cover 10 through the exit aperture 60.

Referring to FIGS. 1-4, the liquid soap dispenser 14 of the preferred embodiment is comprised of first and second side walls 62, back wall 63, front wall 64, and bottom wall 68 which define a reservoir 65 for holding a relatively high viscosity liquid, i.e. having a viscosity greater than the viscosity of water. In one embodiment, the reservoir is used to hold liquid soap, bubble bath, conditioners, moisturizers, or any other suitable liquid used in connection with a bath. Furthermore, in the preferred embodiment of the invention the reservoir 65 is sized to hold an amount of liquid soap or bubble bath typically used for bathing a toddler or other small child. The liquid soap receiving aperture 66 is positioned near the top of the liquid soap dispenser 14 for filling the reservoir 65 with a selected high viscosity fluid such as any of the fluids set forth above. The bottom wall 68 is preferably attached to the inflatable protective side cover 12 and has one or more liquid soap dispensing apertures 67 positioned near the bottom of the liquid soap dispenser 14. Each aperture 67 is sized to allow soap to dispense slowly while water is added to the bath. Preferably, the one or more liquid soap dispensing apertures 67 are positioned adjacent the exit aperture 60 such that liquid soap falls into the tub or other water collecting device (not shown) alongside the water flowing from the water ejecting fixture.

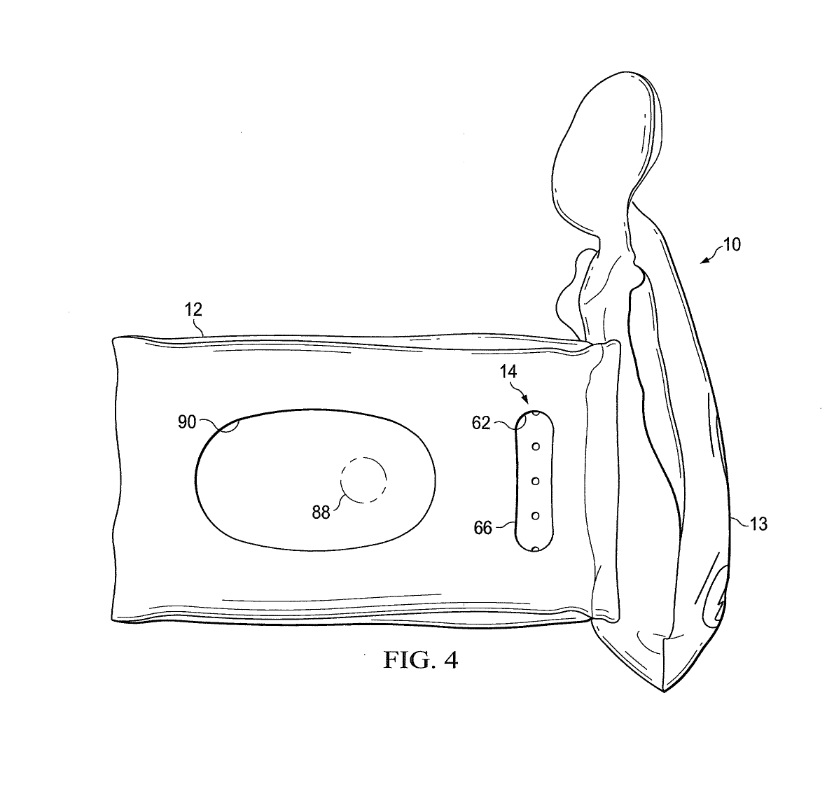

FIGS. 2 and 4 include a projecting water diverter 88 similar to those often found on water ejecting fixtures 56 used in bathtubs. The inflatable protective side cover 12 is constructed with a water diverter receiving aperture 90 in communication with the interior opening 48. The water diverter receiving aperture 90 is sized to receive the water diverter 88 and to permit the combination inflatable protective cover and liquid soap dispenser 10 to be easily installed onto and removed from the water ejecting fixture 56.

The combination inflatable protective cover and liquid soap dispenser 10 has a number of advantages over other dispensers. When inflated, the preferably vinyl material of the inflatable protective side cover 12 is sufficiently flexible to enable the inflatable protective side cover 12 to be more readily placed over a water ejecting bathtub fixture as compared to other liquid soap dispensers made of less flexible molded plastic or rubber. The interior opening of the combination inflatable protective cover and liquid soap dispenser 10 is easily sized so that, when inflated, the interior sidewall 46 is pressed against the bathtub fixture by the internal air pressure of the inflatable protective side cover 12 to ensure that the combination inflatable protective cover and liquid soap dispenser 10 is securely mounted to the bathtub fixture. The combination inflatable protective cover and liquid soap dispenser 10 can also include a water diverter receiving aperture 90 which makes it easier to install onto and remove from a bathtub fixture that incorporates a water diverter. In addition, the water diverter can be accessed and operated without having to remove the combination inflatable protective cover and liquid soap dispenser 10. Another significant advantage of the combination inflatable protective cover and liquid soap dispenser 10 over molded rubber products is that it does not require the construction of a mold for its manufacture. Consequently, various products can be inexpensively updated and manufactured without incurring the substantial cost of creating a mold.

Thus, there has been described and illustrated herein, a combination inflatable protective cover and liquid soap dispenser for a water ejecting fixture such as a bathtub spout in which liquid soap held in the liquid soap dispenser flows by gravity into a bathtub or other water collection device positioned there below. However, those skilled in the art will recognize that many modifications and variations besides those specifically mentioned may be made in the techniques described herein without departing substantially from the concept of the present invention Accordingly, it should be clearly understood that the form of the invention described herein is exemplary only and is not intended as a limitation on the scope of the invention.

What is claimed is:

1. A combination inflatable protective cover and liquid soap dispenser for a water ejecting fixture, comprising:
an inflatable protective cover which forms an interior opening upon inflation, the interior opening being sized to receive a water ejecting fixture for supportably mounting the inflatable protective cover on the fixture, wherein the inflatable protective cover has a liquid soap dispenser having at least one liquid soap dispensing aperture capable of dispensing liquid soap adjacent to water ejected from the water ejecting fixture.

2. The combination inflatable protective cover and liquid soap dispenser as set forth in claim 1 wherein the inflatable protective cover has an inflatable protective front cover attached to an inflatable protective side cover, the inflatable protective side cover having first and second apertures in communication with the interior opening, the first aperture being sized to receive the water ejecting fixture, whereby water ejected by the water ejecting fixture exits through the second aperture.

3. The combination inflatable protective cover and liquid soap dispenser as set forth in claim 2, wherein the inflatable protective side cover has an exterior sidewall and an interior sidewall, wherein the interior sidewall defines the interior opening.

4. The combination inflatable protective cover and liquid soap dispenser as set forth in claim 3, wherein the exterior sidewall and interior sidewall have an inner surface defining multiple chambers within the inflatable protective side cover that are in communication with each other.

5. The combination inflatable protective cover and liquid soap dispenser as set forth in claim 4, wherein the liquid soap dispenser has a liquid soap reservoir in communication with a liquid soap receiving aperture and in communication with the at least one liquid soap dispensing aperture, wherein the at least one liquid soap dispensing aperture is positioned lower than the liquid soap receiving aperture whereby liquid soap is able to exit through the at least one liquid soap dispensing aperture.

6. The combination inflatable protective cover and liquid soap dispenser as set forth in claim 5, wherein the inflatable protective front cover forms a three dimensional sculptural work when inflated having pictorial art work.

7. The combination inflatable protective cover and liquid soap dispenser as set forth in claim 6, wherein said inflatable protective side cover has a third aperture in communication with the interior opening and configured to surround a water diverter located on the water ejecting fixture.

8. The combination inflatable protective cover and liquid soap dispenser as set forth in claim 7, wherein the liquid soap reservoir has a bottom wall containing the at least one liquid soap dispensing aperture and wherein the bottom wall is attached to the inflatable protective side cover.

9. The combination inflatable protective cover and liquid soap dispenser as set forth in claim 8, wherein the liquid soap reservoir has a first side wall, a second side wall, a back wall, and a front wall, wherein the first and second side wall, back wall, and front wall are attached to the liquid soap receiving aperture and the bottom wall so that the liquid soap reservoir is capable of being filled with liquid soap through the liquid soap aperture.

10. The combination inflatable protective cover and liquid soap dispenser as set forth in claim 9, wherein the inflatable protective front cover and the inflatable protective side cover are configured to be separately inflated.

11. The combination inflatable protective cover and liquid soap dispenser as set forth in claim 9, wherein the inflatable protective front cover is integrally formed in communication with the inflatable protective side cover whereby they are configured to be inflated together as a single unit.

12. A method for mounting a combination inflatable protective cover and liquid soap dispenser on a water ejecting fixture comprising:
inflating an inflatable protective cover so as to form an interior opening sized to snugly receive a water ejecting fixture, wherein the inflatable protective cover has a liquid soap dispenser having at least one liquid soap dispensing aperture capable of dispensing liquid soap adjacent to water ejected from the water ejecting fixture; and
sliding the inflatable protective cover over the water ejecting fixture whereby the water ejecting fixture is received within the interior opening so as to support the inflatable protective cover.

13. The method as set forth in claim 12, wherein the inflatable protective cover has an inflatable protective front cover attached to an inflatable protective side cover, the inflatable protective side cover having first and second apertures in communication with the interior opening, the first aperture being sized to receive the water ejecting fixture, whereby water ejected by the water ejecting fixture exits through the second aperture.

14. The method as set forth in claim 13, wherein the inflatable protective side cover has an exterior sidewall and an interior sidewall, wherein the interior sidewall defines the interior opening.

15. The method as set forth in claim 14, wherein the exterior sidewall and interior sidewall have an inner surface defining multiple chambers within the inflatable protective side cover that are in communication with each other.

16. The method as set forth in claim 15, wherein the liquid soap dispenser has a liquid soap reservoir in communication with a liquid soap receiving aperture and in communication with the at least one liquid soap dispensing aperture, wherein the at least one liquid soap dispensing aperture is positioned lower than the liquid soap receiving aperture whereby liquid soap is able to exit through the at least one liquid soap dispensing aperture.

17. The method as set forth in claim 16, wherein the inflatable protective front cover when inflated forms a three dimensional sculptural work having pictorial art work.

18. The method as set forth in claim 17, wherein said inflatable protective side cover has a third aperture in communication with the interior opening and configured to surround a water diverter located on the water ejecting fixture.

19. The method as set forth in claim 18, wherein the liquid soap reservoir has a bottom wall containing the at least one liquid soap dispensing aperture and wherein the bottom wall is attached to the inflatable protective side cover.

20. The method as set forth in claim 19, wherein the liquid soap reservoir has a first side wall, a second side wall, a back wall, and a front wall wherein the first and second side wall, back wall, and front wall are attached to the liquid soap receiving aperture and the bottom wall so that the liquid soap reservoir is capable of being filled with liquid soap through the liquid soap aperture.

21. The method as set forth in claim 20, wherein the inflatable protective front cover and the inflatable protective side cover are configured to be separately inflated.
